(19) United States
(12) Patent Application Publication
(10) Pub. No.: US 2024/0393549 A1
(43) Pub. Date: Nov. 28, 2024

(54) Optical Device and Method of Manufacture

(71) Applicant: Taiwan Semiconductor Manufacturing Co., Ltd., Hsinchu (TW)

(72) Inventors: Tung-Liang Shao, Hsinchu (TW); Yu-Sheng Huang, Hemei Township (TW); Tsung-Fu Tsai, Changhua City (TW); Chen-Hua Yu, Hsinchu (TW)

(21) Appl. No.: 18/324,544

(22) Filed: May 26, 2023

(51) Int. Cl. G02B 6/42

(52) U.S. Cl. CPC G02B 6/4239; G02B 6/4224; G02B 6/4245; G02B 6/4214

(57) ABSTRACT

Optical devices and methods of manufacture are presented in which an optical device and other devices such as laser dies are attached prior to bonding of the optical device and laser die to other device. The optical device and laser die are separated by no more than about 10 μm.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices, and improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-2B illustrate formation of a first optical chiplet, in accordance with some embodiments.

FIG. 3 illustrates placement of the first optical chiplet adjacent to a laser die, in accordance with some embodiments.

FIG. 4 illustrates bonding of the first optical chiplet and the laser die to an interposer substrate, in accordance with some embodiments.

FIGS. 5A-5B illustrate bonding of the first optical chiplet to a second optical chiplet, in accordance with some embodiments.

FIGS. 6A-6B illustrate bonding the first optical chiplet and the second optical chiplet to an integrated fan out package, in accordance with some embodiments.

FIG. 7 illustrates bonding the first optical chiplet and the second optical chiplet to an integrated fan out package with a single side of metallization layers, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a photonic integrated circuit and a laser die are connected together prior to attachment of either device to a substrate. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

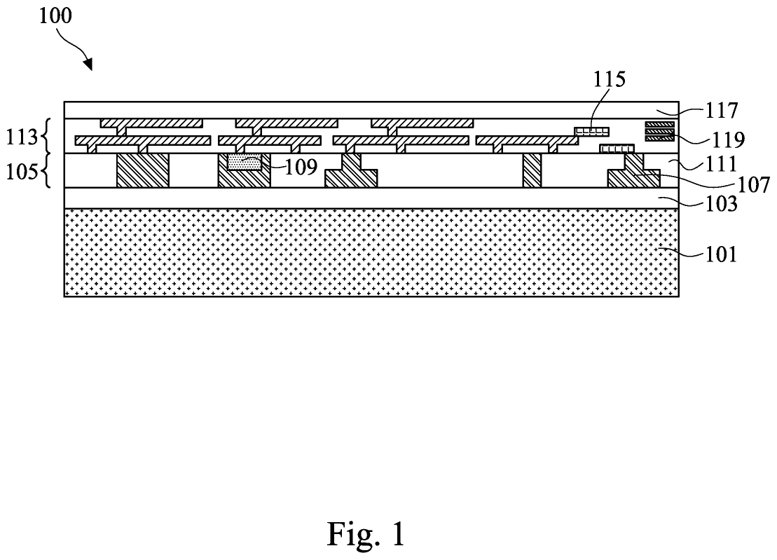

With reference now to FIG. 1, there is illustrated a first optical chiplet 100 in accordance with some embodiments. In the particular embodiment illustrated in FIG. 1, the first optical chiplet 100 is a photonic integrated circuit (PIC) and comprises at this stage a first substrate 101, a first insulator layer 103, and a layer of material for a first active layer 105 of first optical components 107. In an embodiment, at a beginning of the manufacturing process of the first optical chiplet 100, the first substrate 101, the first insulator layer 103, and the layer of material for the first active layer 105 of first optical components 107 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 105 and can additionally, in some embodiments, serve as a portion of cladding material that surrounds the subsequently manufactured first optical components 107 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material for the first active layer 105 is initially (prior to patterning) a conformal layer of material that will be used to begin manufacturing the first active layer 105 of the first optical components 107. In an embodiment the material for the first active layer 105 may be a translucent material that can be used as a core material for the desired first optical components 107, such as a semiconductor material such as silicon, germanium, silicon germanium, combinations of these, or the like, while in other embodiments the material for the first active layer 105 may be a dielectric material such as silicon nitride or the like, although in other embodiments the material for the first active layer 105 may be III-V materials, lithium niobate materials, or polymers. In embodiments in which the material of the first active layer 105 is deposited, the material for the first active layer 105 may be deposited using a method such as epitaxial growth, chemical vapor deposition, atomic layer deposition, physical vapor deposition, combinations of these, or the like. In other embodiments in which the first insulator layer 103 is formed using an implantation method, the material of the first active layer 105 may initially be part of the first substrate 101 prior to the implantation process to form the first insulation layer 103. However, any suitable materials and methods of manufacture may be utilized to form the material of the first active layer 105.

FIG. 1 additionally illustrates that, once the material for the first active layer 105 is ready, the first optical components 107 for the first active layer 105 are manufactured using the material for the first active layer 105. In embodiments the first optical components 107 of the first active layer 105 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.). directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 107 may be used.

To begin forming the first active layer 105 of first optical components 107 from the initial material, the material for the first active layer 105 may be patterned into the desired shapes for the first active layer 105 of first optical components 107. In an embodiment the material for the first active layer 105 may be patterned using, e.g., one or more photolithographic masking and etching processes. However, any suitable method of patterning the material for the first active layer 105 may be utilized. For some of the first optical components 107, such as waveguides or edge couplers, the patterning process may be all or at least most of the manufacturing that is used to form these first optical components 107 components.

For those components that utilize further manufacturing processes, such as Mach-Zehnder silicon-photonic switches that utilize resistive heating elements, additional processing may be performed either before or after the patterning of the material for the first active layer 105. For example, implantation processes, additional deposition and patterning processes for different materials (e.g., resistive heating elements, III-V materials for converters), combinations of all of these processes, or the like, can be utilized to help further the manufacturing of the various desired first optical components 107. In a particular embodiment, and as specifically illustrated in FIG. 1. in some embodiments an epitaxial deposition of a semiconductor material 109 such as germanium (used, e.g., for electricity/optics signal modulation and transversion) may be performed on a patterned portion of the material of the first active layer 105. In such an embodiment the semiconductor material 109 may be epitaxially grown in order to help manufacture, e.g., a photodiode for an optical-to-electrical converter. All such manufacturing processes and all suitable first optical components 107 may be manufactured, and all such combinations are fully intended to be included within the scope of the embodiments.

Once the individual first optical components 107 of the first active layer 105 have been formed, a second insulating layer 111 may be deposited to cover the first optical components 107 and provide additional cladding material. In an embodiment the second insulator layer 111 may be a dielectric layer that separates the individual components of the first active layer 105 from each other and from the overlying structures and can additionally serve as another portion of cladding material that surrounds the first optical components 107. In an embodiment the second insulator layer 111 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulating layer 111 has been deposited, the material may be planarized using, e.g., a chemical mechanical polishing process in order to either planarize a top surface of the second insulating layer 111 (in embodiments in which the second insulating layer 111 is intended to fully cover the first optical components 107) or else planarize the second insulating layer 111 with top surfaces of the first optical components 107. However, any suitable material and method of manufacture may be used.

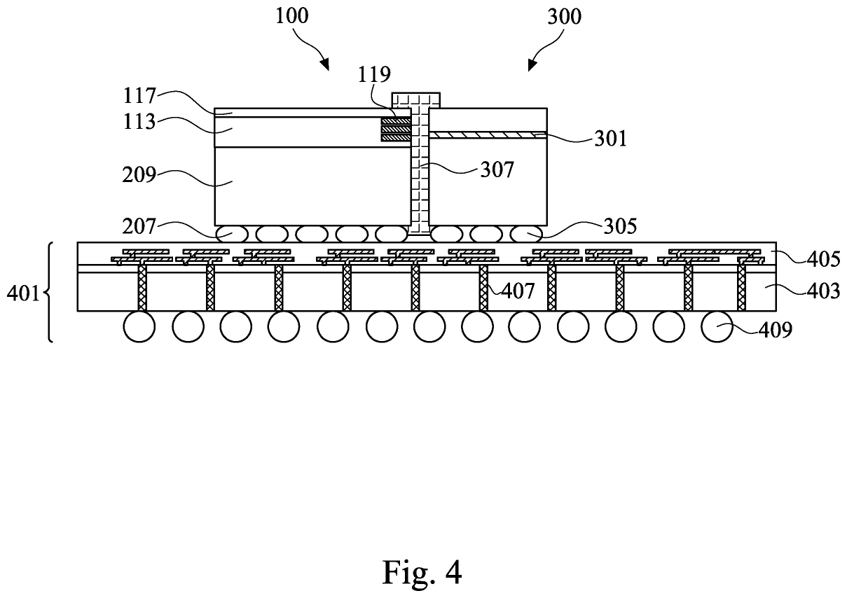

Once the first optical components 107 of the first active layer 105 have been manufactured and the second insulating layer 111 has been formed, first metallization layers 113 are formed in order to electrically connect the first active layer 105 of first optical components 107 to control circuitry, to each other, and to subsequently attached devices (not illustrated in FIG. 1 but illustrated and described further below with respect to FIG. 4). In an embodiment the first metallization layers 113 are formed of alternating layers of dielectric and conductive material and may be formed through any suitable processes (such as deposition, damascene, dual damascene, etc.). In particular embodiments there may be multiple layers of metallization used to interconnect the various first optical components 107, but the precise number of first metallization layers 113 is dependent upon the design of the first optical chiplet 100.

Additionally, during the manufacture of the first metallization layers 113, one or more second optical components 115 may be formed as part of the first metallization layers 113. In some embodiments the second optical components 115 of the first metallization layers 113 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 115.

In an embodiment the one or more second optical components 115 may be formed by initially depositing a material for the one or more second optical components 115. In an embodiment the material for the one or more second optical components 115 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 115 has been deposited or otherwise formed, the material may be patterned into the desired shapes for the one or more second optical components 115. In an embodiment the material of the one or more second optical components 115 may be patterned using, e.g., one or more photolithographic masking and etching processes. However, any suitable method of patterning the material for the one or more second optical components 115 may be utilized.

For some of the one or more second optical components 115, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 115. For example, implantation processes, additional deposition and patterning processes for different materials, combinations of all of these processes, or the like, and can be utilized to help further the manufacturing of the various desired one or more second optical components 115. All such manufacturing processes and all suitable one or more second optical components 115 may be manufactured, and all such combinations are fully intended to be included within the scope of the embodiments.

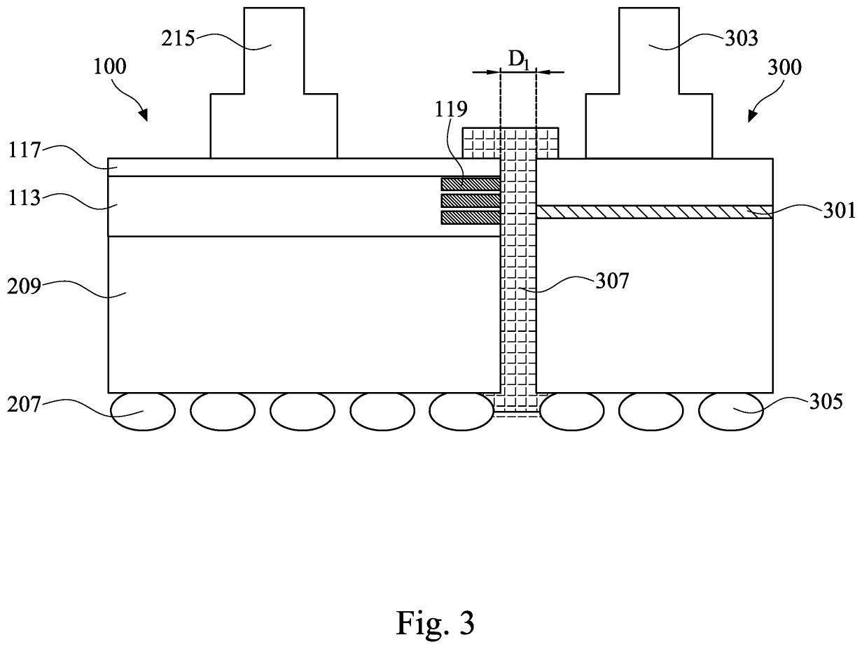

In a particular embodiment the second optical components 115 may particularly comprise an edge coupler 119 located adjacent to an edge of the first optical chiplet 100. In an embodiment the edge coupler 119 comprises multiple waveguides located at different levels of the first metallization layer 113, wherein the multiple waveguides collectively work together to receive light signals from outside of the first optical chiplet 100, such as light from a subsequently attached laser die 300 (not illustrated in FIG. 1 but illustrated and described further below in FIG. 3). However, any suitable combination of optical components may be utilized.

Once the one or more second optical components 115 of the first metallization layers 113 have been manufactured, a first passivation layer 117 is formed over the first metallization layers 113. The first passivation layer 117 may be deposited using any suitable method, such as CVD, high-density plasma chemical vapor deposition (HDPCVD), PVD, atomic layer deposition (ALD), or the like. However, any suitable materials and deposition processes may be utilized.

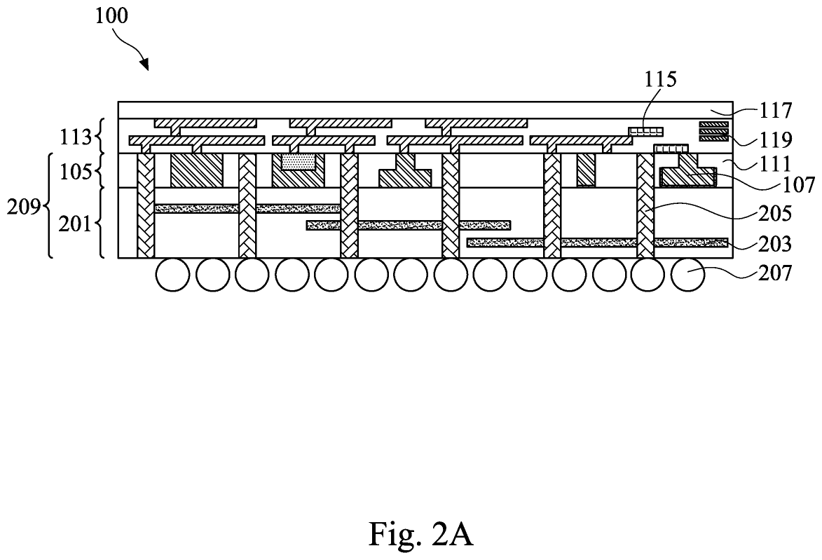

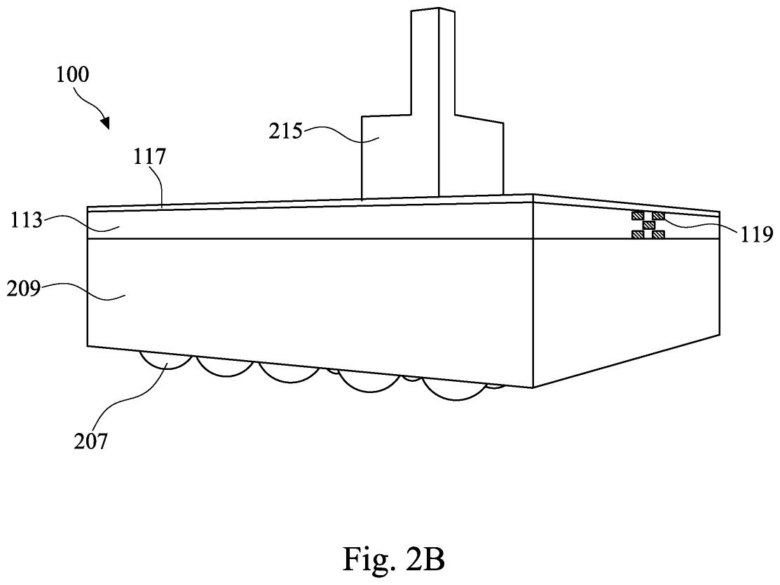

FIG. 2A illustrates a removal of the first substrate 101 and, optionally, the first insulating layer 103, thereby exposing the first active layer 105 of first optical components 107. In an embodiment the first substrate 101 and the first insulating layer 103 may be removed using a planarization process, such as a chemical mechanical polishing process, a grinding process, one or more etching processes, combinations of these, or the like. However, any suitable method may be used in order to remove the first substrate 101 and/or the first insulating layer 103.

Once the first substrate 101 and the first insulating layer 103 have been removed, a second active layer 201 of third optical components 203 (which collectively with the first active layer 105 forms a combined active layer 209) may be formed on a back side of the first active layer 105. In an embodiment the second active layer 201 of third optical components 203 may be formed using similar materials and similar processes as the second optical components 115 of the first metallization layers 113 (described above with respect to FIG. 1). For example, the second active layer 201 of third optical components 203 may be formed of alternating layers of a cladding material such as silicon oxide and core material such as silicon nitride formed using deposition and patterning processes in order to form optical components such as waveguides and the like.

FIG. 2A additionally illustrates formation of first through device vias (TDVs) 205 and formation of first external connectors 207. In an embodiment the first through device vias 205 extend through the second active layer 201 and the first active layer 105 so as to provide a quick passage of power, data, and ground through the first optical chiplet 100. In an embodiment the first through device vias 205 may be formed by initially forming through device via openings into the first optical chiplet 100. The through device via openings may be formed by applying and developing a suitable photoresist (not shown), and removing portions of the second active layer 201 and the first optical chiplet 100 that are exposed.

Once the through device via openings have been formed within the first optical chiplet 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may alternatively be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 205 have been formed, second metallization layers (not separately illustrated in FIG. 2A) may be formed in electrical connection with the first through device vias 205. In an embodiment the second metallization layers may be formed as described above with respect to the first metallization layers 113, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The first external connectors 207 may be formed to provide conductive regions for contact between either the first through device vias 205 or the second metallization layers to other external devices. The first external connectors 207 may be conductive bumps (e.g., C4 bumps, ball grid arrays, microbumps, etc.) or conductive pillars utilizing materials such as solder and copper. In an embodiment in which the first external connectors 207 are contact bumps, the first external connectors 207 may comprise a material such as tin, or other suitable materials, such as silver, lead-free tin, or copper. In an embodiment in which the first external connectors 207 are tin solder bumps, the first external connectors 207 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

FIG. 2B illustrates a three-dimensional view of the first optical chiplet 100 in a simplified form. In this embodiment the first active layer 105 and the second active layer 201 are illustrated as the combined active layer 209, and the overlying first metallization layers 113 are illustrated as overlying the combined active layer 209. Additionally, each of the second optical components 115 located within the first metallization layers 113 have been removed except for the edge coupler 119.

As illustrated, the first optical chiplet 100 is being prepared for attachment to, e.g., the laser die 300. In particular, the first optical chiplet 100 has been singulated from any other optical chiplets that may have been formed using the first substrate 101. For example, the first optical chiplet 100 may be singulated using a saw to slice through adjacent optical chiplets. However, any suitable method, such as one or more etch processes, may be utilized.

Once the first optical chiplet 100 has been singulated, the first optical chiplet 100 is attached to a first chuck 215 which is utilized to control the movement and placement of the first optical chiplet 100. In an embodiment the first chuck 215 may be a vacuum chuck which utilizes reduced pressures in order to hold and control the first optical chiplet 100. However, any suitable type of chucks, such as an electrostatic chuck, may also be utilized.

FIG. 3 illustrates a connection of the first optical chiplet 100 to the laser die 300 in a photonic integrated circuit to laser die integration (PIC-to-LD integration), to form a photonic chiplet integration. In some embodiments, the laser die 300 may be utilized to generate light in order to power the other optical components (e.g., the first optical components 107, the second optical components 115, the third optical components 203, etc.), and may comprise light generating structures such as one or more laser diodes (not separately illustrated). In particular embodiments the laser diodes may be Fabry-Perot Diodes, and may be based on III-V materials, II-VI materials, or any other suitable set of materials.

In a particular embodiment the laser die 300 may comprise a first contact 301, a first buffer layer, a first active diode layer comprising multiple quantum wells (MQWs), a second buffer layer, and a second contact (only some of which are illustrated in FIG. 3 for clarity) in order to generate the desired light. Additionally, the generated light may be output from the laser die 300 through, e.g., the first contact 301. However, any suitable structures may be utilized in order to form the laser die 300 and generate the desired light.

Additionally, the laser die 300 may also comprise second external connectors 305. In an embodiment the second external connectors 305 may be similar to the first external connectors 207, such as by being solder balls. However, any suitable materials and shape of connections may also be utilized.

Once the laser die 300 has been formed or otherwise received, the laser die 300 may be positioned adjacent to the first optical chiplet 100. In an embodiment the laser die 300 may be positioned by initially attaching the laser die 300 to a second chuck 303. In an embodiment the second chuck 303 may be similar to the first chuck 215, such as by being a vacuum chuck. However, any suitable type of chuck may be utilized.

Once the laser die 300 has been attached to the second chuck 303, the first chuck 215 and the second chuck 303 may be utilized to align the first optical chiplet 100 with the laser die 300. In an embodiment the edge coupler 119 within the first optical chiplet 100 may be used as an alignment mark during the alignment process, helping the first chuck 215 and the second chuck 303 ensure that the first optical chiplet 100 and the laser die 300 are in the desired positions and within the desired dimensions. However, any suitable alignment process and/or structures may be utilized.

Additionally, in the particular embodiment in which the first contact 301 is utilized to output the light generated from the laser die 300, the first chuck 215 and the second chuck 303 are used to align the output of the laser die 300 (e.g., the first contact 301) to the edge coupler 119, such that light output from the laser die 300 is received by the edge coupler 119. However, any suitable components may be aligned with each other.

In a particular embodiment the first chuck 215 and the second chuck 303 are used to align the first optical chiplet 100 and the laser die 300 such that the first optical chiplet 100 is separated from the laser die 300 by a first distance D₁. In some embodiments the first distance D₁ is between about 0.5 μm and about 10 μm. If the first distance D₁ is greater than this amount, then losses from the transmission of the generated light through the first distance D₁ may be too great. Additionally, if the first distance D₁ is less than this amount, there might not be enough space between the laser die 300 and the first optical chiplet 100 for subsequently applied structures such as a first glue 307 (if desired).

Once the first chuck 215 and the second chuck 303 have been placed adjacent to each other, the first glue 307 may be dispensed to adhere the first optical chiplet 100 to the laser die 300 at the first distance D₁. In some embodiments, the first glue 307 comprises a polymer material such as epoxy-acrylate oligomers, and may have a refractive index between about 1 and about 3, that is dispensed using, e.g., an injection method that injects the first glue 307 between the laser die 300 and the first optical chiplet 100. However, any suitable material and any suitable method of dispensing the first glue 307 may be utilized.

Once the first glue 307 has been dispensed, the first glue 307 may be cured in order to harden the first glue 307 and set the first distance D₁. In an embodiment the first glue 307 may be cured using a thermal cure process, whereby a temperature of the first glue 307 is raised to cure the first glue 307. However, any other suitable curing process, such as an ultraviolet cure, may be used.

By injecting and curing the first glue 307 between the first optical chiplet 100 and the laser die 300, the entire region between the first optical chiplet 100 and the laser die 300 may be filled by the first glue 307. As such, because the first glue 307 is as thick as the region between the first optical chiplet 100 and the laser die 300, the first glue 307 within this region has a first width that is equal to the first distance D₁.

Additionally, in some embodiments the first glue 307 may extend above the top surfaces of the first optical chiplet 100 and the laser die 300. As such, unconstrained by the sidewalls of the first optical chiplet 100 and the laser die 300, the first glue 307 at this point may expand horizontally to cover at least a portion of the top surfaces of the first optical chiplet 100 and the laser die 300. As such, at a point above the first optical chiplet 100 and the laser die 300, the first glue 307 has a second width that is greater than the first distance D₁.

Also, because the first glue 307 is dispensed into the region between the first optical chiplet 100 and the laser die 300, the first glue 307 will also extend away from the bottom side of the first optical chiplet 100 and the laser die 300. As such, unconstrained by the sidewalls of the first optical chiplet 100 and the laser die 300, the first glue 307 at this point may also expand horizontally to cover at least a portion of the bottom surfaces of the first optical chiplet 100 and the laser die 300. In some embodiments the first glue 307 may expand horizontally enough to be in physical contact with either or both of the first external connectors 207 and the second external connectors 305. However, the first glue 307 will not be in physical contact with all of the first external connectors 207 and the second external connectors 305.

Of course, while the use of the first glue 307 is a particular embodiment that has been described, the first glue 307 is merely one embodiment and this description is not intended to limit the scope of the disclosure. For example, in other embodiments the first optical chiplet 100 and the laser die 300 may be joined by aligning and placing the first optical chiplet 100 and the laser die 300 into physical contact and performing a welding process, such as a laser welding process. However, any suitable method of adhering the first optical chiplet 100 and the laser die 300 may be utilized, and all such methods are fully intended to be included within the scope of the embodiments.

FIG. 4 illustrates a bonding of the first optical chiplet 100 and the laser die 300 to an interposer substrate 401, that is used to couple the first optical chiplet 100 and laser die 300 with other devices to form, for example, a chip-on-wafer-on-substrate (CoWoS®). In an embodiment the interposer substrate 401 comprises a semiconductor substrate 403, third metallization layers 405, second through device vias (TDVs) 407, and second external connectors 409. The semiconductor substrate 403 may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, active devices (not separately illustrated) may be added to the semiconductor substrate 403. The active devices comprise a wide variety of active devices and passive devices such as capacitors, resistors, inductors and the like that may be used to generate the desired structural and functional requirements of the design for the semiconductor substrate 403. The active devices may be formed using any suitable methods either within or else on the semiconductor substrate 403.

The third metallization layers 405 are formed over the semiconductor substrate 403 and the active devices and are designed to connect the various active devices to form functional circuitry. In an embodiment the third metallization layers 405 are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, at any desired point in the manufacturing process, the second TDVs 407 may be formed within the semiconductor substrate 403 and, if desired, one or more layers of the third metallization layers 405, in order to provide electrical connectivity from a front side of the semiconductor substrate 403 to a back side of the semiconductor substrate 403. In an embodiment the second TDVs 407 may be formed by initially forming through device via (TDV) openings into the semiconductor substrate 403 and, if desired, any of the overlying third metallization layers 405 (e.g., after the desired third metallization layer has been formed but prior to formation of the next overlying third metallization layer). The TDV openings may be formed by applying and developing a suitable photoresist, and removing portions of the underlying materials that are exposed to a desired depth. The TDV openings may be formed so as to extend into the semiconductor substrate 403 to a depth greater than the eventual desired height of the semiconductor substrate 403.

Once the TDV openings have been formed within the semiconductor substrate 403 and or any third metallization layers 405, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate 403 may be thinned until the second TDVs 407 have been exposed. In an embodiment the semiconductor substrate 403 may be thinned using, e.g., a chemical mechanical polishing process, a grinding process, or the like. Further, once exposed, the second TDVs 407 may be recessed using, e.g., one or more etching processes, such as a wet etch process in order to recess the semiconductor substrate 403 so that the second TDVs 407 extend out of the semiconductor substrate 403.

In an embodiment the second external connectors 409 may be placed on the semiconductor substrate 403 in electrical connection with the second TDVs 407 and may be, e.g., a ball grid array (BGA) which comprises a eutectic material such as solder, although any suitable materials may be used. Optionally, an underbump metallization or additional metallization layers (not separately illustrated in FIG. 4) may be utilized between the semiconductor substrate 403 and the second external connectors 409. In an embodiment in which the second external connectors 409 are solder bumps, the second external connectors 409 may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the second external connectors 409 have been formed, a test may be performed to ensure that the structure is suitable for further processing.

Once the interposer substrate 401 has been formed, the first optical chiplet 100 and the laser die 300 are collectively bonded to the interposer substrate 401 simultaneously. In an embodiment the first optical chiplet 100 and the laser die 300 may be attached to the interposer substrate 401 by aligning the first external connectors 207 and the second external connectors 305 with conductive portions of the interposer substrate 401. Once aligned and in physical contact, the first external connectors 207 and the second external connectors 305 are reflowed by raising the temperature of the first external connectors 207 and the second external connectors 305 past a eutectic point of the first external connectors 207 and the second external connectors 305, thereby shifting the material of the first external connectors 207 and the second external connectors 305 to a liquid phase. Once reflowed, the temperature is reduced in order to shift the material of the first external connectors 207 and the second external connectors 305 back to a solid phase, thereby bonding the first optical chiplet 100 and the laser die 300 to the interposer substrate 401.

By dispensing the first glue 307 between the first optical chiplet 100 and the laser die 300 prior to bonding the first optical chiplet 100 and the laser die 300 to the interposer substrate 401, the first glue 307 may or may not be in physical contact with the interposer substrate 401. For example, in some embodiments the first glue 307 may be separated from the interposer substrate 401 by a first gap. In other embodiments the first glue 307 may extend to be in physical contact with the top surface of the interposer substrate 401.

Additionally, by adhering the first optical chiplet 100 and the laser die 300 prior to bonding either one to the interposer substrate 401, the distance between the first optical chiplet 100 and the laser die 300 can be reduced to less than about 10 μm (instead of greater than about 30 μm as is required if the first optical chiplet 100 and the laser die 300 are bonded to the interposer substrate 401 first). By reducing the distance between the two devices, coupling losses between the first optical chiplet 100 and the laser die 300 can also be reduced while transporting light between the first optical chiplet 100 and the laser die 300. As such, direct coupling can be achieved without the need for additional structures.

Optionally, and not illustrated in FIG. 4, the interposer substrate 401 may additionally be bonded to a second substrate with, e.g., the second external connectors 409. In an embodiment the second substrate may be a package substrate, which may be a printed circuit board (PCB) or the like. The second substrate may include one or more dielectric layers and electrically conductive features, such as conductive lines and vias.

In some embodiments, the second substrate may include through-vias, active devices, passive devices, and the like. The second substrate may further include conductive pads formed at the upper and lower surfaces of the second substrate.

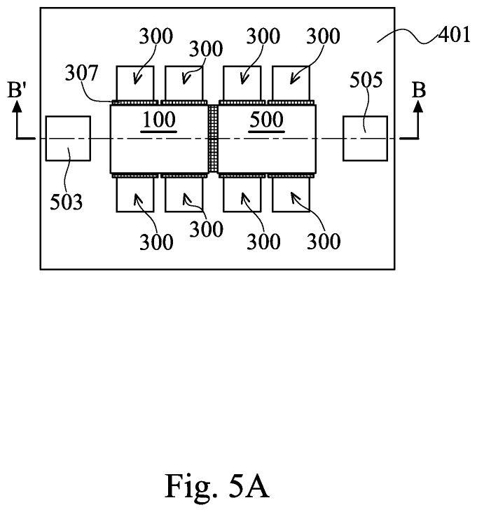

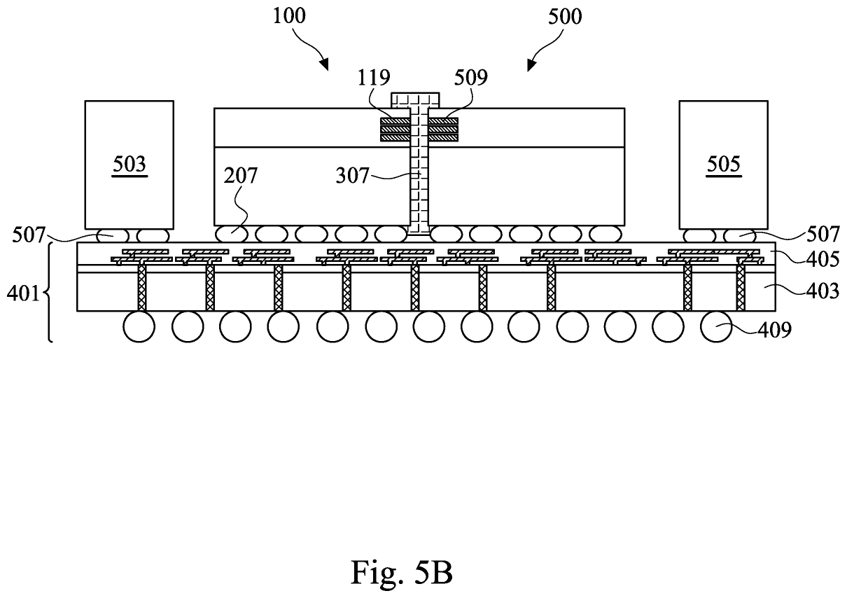

FIGS. 5A-5B illustrate a top-down view and a cross-sectional view of the first optical chiplet 100 being adhered to a second optical chiplet 500 (in a PIC-to-PIC integration) and multiple laser dies 300 and then the unit collectively bonded to the interposer substrate 401, with FIG. 5B illustrating a cross-sectional view of FIG. 5A through line B-B′. In the embodiment illustrated in FIGS. 5A-5B, the first optical chiplet 100 is adhered to and receives generated light from four individual laser dies 300. In a particular embodiment the first optical chiplet 100 is adhered to each of the laser dies 300 as described above with respect to FIG. 3, such as by being positioned before the first glue 307 is dispensed prior to bonding to the interposer substrate 401. However, any suitable connections between the individual laser dies 300 may be utilized.

FIGS. 5A-5B additionally illustrate the second optical chiplet 500 adhered to the first optical chiplet 100. In an embodiment the second optical chiplet 500 may be manufactured with similar structures and similar processes as those described above with respect to FIGS. 1-2A, and may be designed to work in conjunction with the first optical chiplet 100. For example, the second optical chiplet 500 may be manufactured with a second edge coupler 509 formed as part of the second optical components 115 located within the first metallization layers 113.

In an embodiment the second optical chiplet 500 may be adhered to the first optical chiplet 100 prior to bonding the second optical chiplet 500 to the interposer substrate 401. In an embodiment the second optical chiplet 500 is adhered to the first optical chiplet 100 using similar methods and processes as described above with respect to FIG. 3. For example, the second optical chiplet 500 and the first optical chiplet 100 are placed adjacent to each other such that the second edge coupler 509 is aligned with the edge coupler 119 so as to transmit signals between the first optical chiplet 100 and the second optical chiplet 500. Additionally, the second optical chiplet 500 and the first optical chiplet 100 may be placed to the first distance D₁ or less, and the first glue 307 is dispensed and cured between the first optical chiplet 100 and the second optical chiplet 500. However, any suitable methods of placing and connecting the first optical chiplet 100 and the second optical chiplet 500 are fully intended to be included within the scope of the embodiments.

In addition to the second optical chiplet 500 being adhered to the first optical chiplet 100, the second optical chiplet 500 may also be adhered to one or more laser dies 300. In an embodiment the second optical chiplet 500 is adhered to the one or more laser dies 300 using similar methods and processes as described above with respect to FIG. 3. For example, the second optical chiplet 500 and the individual laser dies 300 are placed adjacent to each other within the first distance D₁, and the first glue 307 is dispensed and cured between the laser dies 300 and the second optical chiplet 500. However, any suitable methods of placing and connecting the laser dies 300 are fully intended to be included within the scope of the embodiments.

Once the second optical chiplet 500 has been adhered to the first optical chiplet 100 and the laser dies 300, the second optical chiplet 500 may be bonded to the interposer substrate 401 simultaneously with the other structures. In an embodiment the second optical chiplet 500 may be bonded as described above with respect to FIG. 4. However, any suitable bonding process may be utilized.

FIGS. 5A-5B additionally illustrate a placement and bonding of a first semiconductor device 503 and a second semiconductor device 505 on the interposer substrate 401. In some embodiments, the first semiconductor device 503 and the second semiconductor device 505 are electronic integrated circuits (EIC—e.g., devices without optical devices) and each may have a semiconductor substrate, a layer of active devices, an overlying interconnect structure, and fourth external connectors 507. In an embodiment the semiconductor substrate may be similar to the first substrate 101 (e.g., a semiconductor material such as silicon or silicon germanium), the active devices may be transistors, capacitors, resistors, and the like formed over the semiconductor substrate, the interconnect structure may be similar to the first metallization layers 113 (without optical components), and the fourth external connectors 507 may be similar to the first external connectors 207. However, any suitable devices may be utilized.

In an embodiment the first semiconductor device 503 and the second semiconductor device 505 may be configured to work with the first optical chiplet 100, the second optical chiplet 500 and each other for a desired functionality. In some embodiments the first semiconductor device 503 and the second semiconductor device 505 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

The first semiconductor device 503 and the second semiconductor device 505 are bonded to the interposer substrate 401 using the fourth external connectors 507. In an embodiment the first semiconductor device 503 and the second semiconductor device 505 may be placed on the interposer substrate 401 and then a reflow process may be performed to raise the temperature of the fourth external connectors 507 until the fourth external connectors 507 liquefy. Once liquid, the temperature is then reduced until the fourth external connectors 507 solidify and bond the first semiconductor device 503 and the second semiconductor device 505 to the interposer substrate 401.

By adhering the first optical chiplet 100 and the second optical chiplet 500 prior to bonding either one to the interposer substrate 401, the distance between the first optical chiplet 100 and the second optical chiplet 500 can be reduced to less than about 10 μm. By reducing the distance between the two devices, coupling losses between the first optical chiplet 100 and the second optical chiplet 500 can also be reduced while transmitting light between the first optical chiplet 100 and the second optical chiplet 500. As such, direct coupling can be achieved without the need for additional structures.

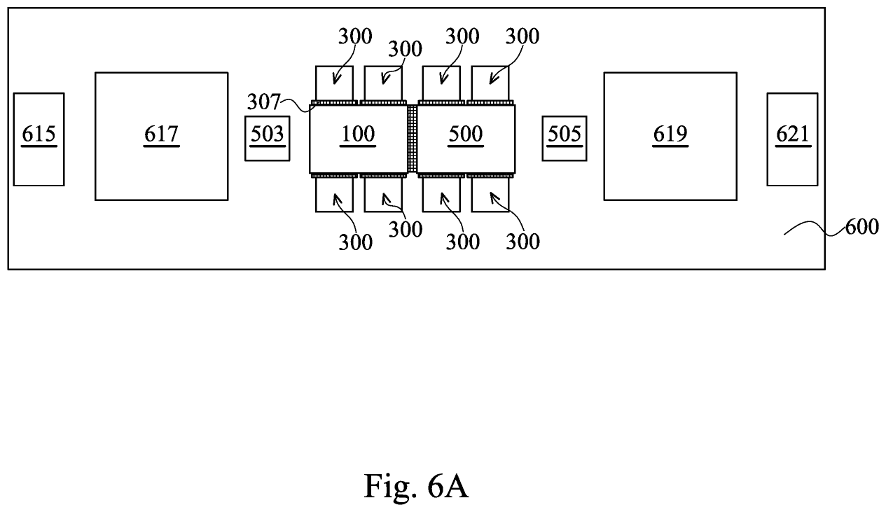

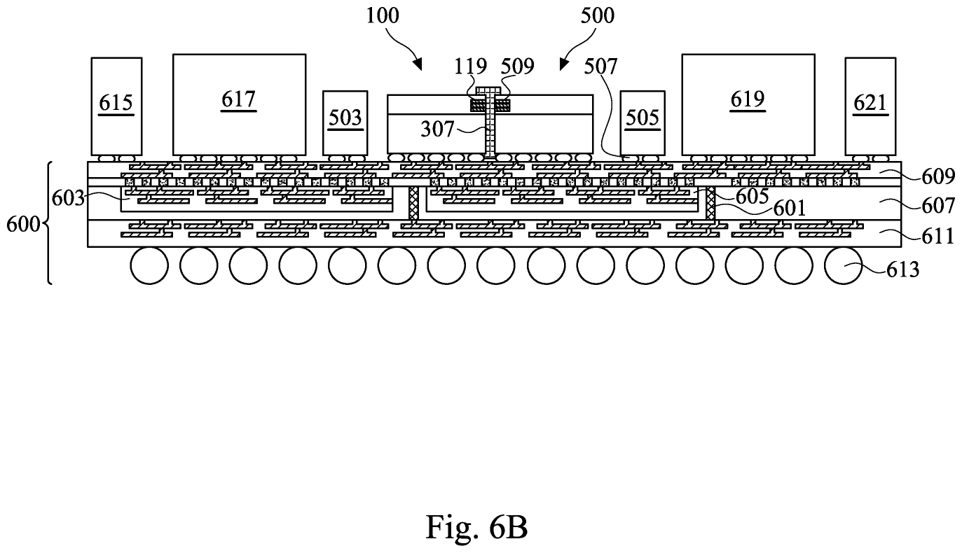

FIGS. 6A and 6B illustrate another embodiment in which the first optical chiplet 100 and the second optical chiplet 500 are bonded to an integrated fan-out (InFO) substrate 600. In this embodiment InFO TDVs 601 are initially formed (using, e.g., a photolithographic masking and plating process) on a substrate (not separately illustrated) adjacent to, e.g., a third semiconductor device 603 and a fourth semiconductor device 605. In an embodiment the third semiconductor device 603 and the fourth semiconductor device 605 may be local silicon interconnects (LSI), or else may be semiconductor devices similar to the first semiconductor device 503 and/or the second semiconductor device 505.

Once in place, the InFO TDVs 601, the third semiconductor device 603, and the fourth semiconductor device 605 are encapsulated with an encapsulant 607, and second metallization layers 609 (similar to the first metallization layers 113) may be formed. The substrate may then be removed, third metallization layers 611 may be formed on an opposite side of the InFO TDVs 601, and fourth external connectors 613 (similar to the first external connectors 207) are placed.

Once the InFO package 600 has been formed, the first optical chiplet 100, the second optical chiplet 500, the laser dies 300, the first semiconductor device 503, and the second semiconductor device 505 may be bonded to the InFO substrate 600. For example, the first optical chiplet 100, the second optical chiplet 500, the laser dies 300, the first semiconductor device 503, and the second semiconductor device 505 are placed onto the InFO substrate 600 and the first external connectors 207, the second external connectors 305, and the fourth external connectors 507 are reflowed. However, any suitable processes and structures may be utilized.

FIGS. 6A-6B additionally illustrate a bonding of a fifth semiconductor device 615, a sixth semiconductor device 617, a seventh semiconductor device 619, and an eighth semiconductor device 621 to the InFO substrate 600. In an embodiment the fifth semiconductor device 615, the sixth semiconductor device 617, the seventh semiconductor device 619, and the eighth semiconductor device 621 may be similar to the first semiconductor device 503 and/or the second semiconductor device 505, such as by being a high bandwidth memory stack or an XPU that is bonded using external connections such as solder. However, any suitable functionality and any suitable method of bonding may be utilized.

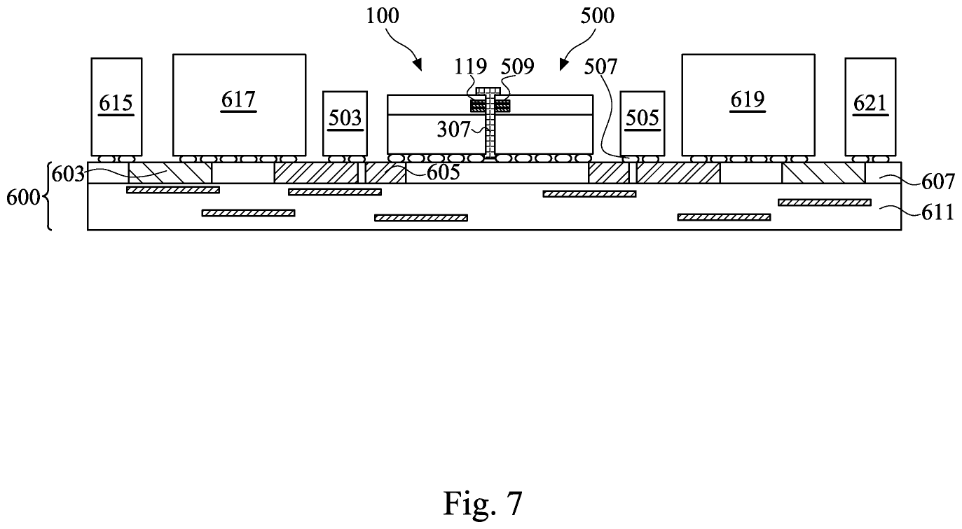

FIG. 7 illustrates yet another embodiment in which the InFO substrate 600 (illustrated in simplified form in FIG. 7), instead of comprising the second metallization layers 609 and the third metallization layers 611, only comprises the third metallization layers 611, in a CoWoS-L configuration. As such, because the second metallization layers 609 are not present, the overlying devices may be directly bonded to the third semiconductor device 603, the fourth semiconductor device 605, and other semiconductor devices such as local silicon interconnects.

By adhering optical devices (e.g., the first optical chiplet 100, the second optical chiplet 500, the laser dies 300, etc.) together prior to bonding either one to the interposer substrate 401, the distance between the optical devices can be reduced. By reducing the distance between the individual devices, coupling losses between the adjacent devices can also be reduced while light is transported from one device to an adjacent device. As such, direct coupling between the various devices can be achieved without the need for additional structures.

In an embodiment, a method of manufacturing an optical device includes: placing a first optical chiplet; and placing a laser die separated from the first optical chiplet by no more than about 10 μm. In an embodiment the method further includes dispensing a first glue between the first optical chiplet and the laser die. In an embodiment the method further includes placing a second optical chiplet separated from the first optical chiplet by no more than about 10 μm. In an embodiment the method further includes dispensing a second glue between the second optical chiplet and the first optical chiplet. In an embodiment the method further includes simultaneously bonding the first optical chiplet, the second optical chiplet, and the laser die to a substrate. In an embodiment the method further includes simultaneously bonding the first optical chiplet and the laser die to a substrate. In an embodiment the substrate comprises a local silicon interconnect.

In another embodiment, a method of manufacturing an optical device includes: attaching a first optical chiplet to a first chuck; attaching a laser die to a second chuck; moving at least one of the first chuck and the second chuck to align an edge coupler of the first optical chiplet with an output of the laser die; and dispensing a first glue between the first optical chiplet and the laser die, wherein after the dispensing the first glue the first glue has a first thickness less than about 10 μm. In an embodiment the method further includes dispensing a second glue between the first optical chiplet and a second optical chiplet, wherein after the dispensing the second glue the second glue has a second thickness less than about 10 μm. In an embodiment the method further includes dispensing a second glue between the first optical chiplet and a second laser die, wherein after the dispensing the second glue the second glue has a second thickness less than about 10 μm. In an embodiment the method further includes simultaneously bonding the first optical chiplet and the laser die to a substrate. In an embodiment the substrate is an integrated fan out substrate. In an embodiment the integrated fan out substrate comprises a local silicon interconnect. In an embodiment the method further includes using an edge coupler within the first optical chiplet as an alignment mark during the moving at least one of the first chuck and the second chuck.

In yet another embodiment, an optical device includes: a first optical chiplet; and a laser die, wherein a first distance between the laser die and the first optical chiplet is less than about 10 μm. In an embodiment the optical device includes a first glue extending from the first optical chiplet and the laser die. In an embodiment the optical device includes a second optical chiplet, wherein a second distance between the first optical chiplet and the second optical chiplet is less than about 10 μm. In an embodiment the optical device includes a second laser die, wherein a third distance between the first optical chiplet and the third laser die is less than about 10 μm. In an embodiment the optical device includes a local silicon interconnect connecting the first optical chiplet to an electronic integrated circuit. In an embodiment the optical device includes a metallization layer located on an opposite side of the local silicon interconnect from the first optical chiplet.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
placing a first optical chiplet;
placing a laser die separated from the first optical chiplet by no more than about 10 μm, to form a photonic chiplet integration; and
placing the photonic chiplet integration to a substrate.

2. The method of claim 1, further comprising dispensing a first glue between the first optical chiplet and the laser die.

3. The method of claim 2, further comprising placing a second optical chiplet separated from the first optical chiplet by no more than about 10 μm.

4. The method of claim 3, further comprising dispensing a second glue between the second optical chiplet and the first optical chiplet.

5. The method of claim 4, further comprising simultaneously bonding the first optical chiplet, the second optical chiplet, and the laser die to a substrate.

6. The method of claim 1, further comprising simultaneously bonding the first optical chiplet and the laser die to the substrate.

7. The method of claim 6, wherein the substrate comprises a local silicon interconnect.

8. A method of manufacturing an optical device, the method comprising:
attaching a first optical chiplet to a first chuck;
attaching a laser die to a second chuck;
moving at least one of the first chuck and the second chuck to align an edge coupler of the first optical chiplet with an output of the laser die; and
dispensing a first glue between the first optical chiplet and the laser die, wherein after the dispensing the first glue, the first glue has a first thickness less than about 10 μm.

9. The method of claim 8, further comprising dispensing a second glue between the first optical chiplet and a second optical chiplet, wherein after the dispensing the second glue the second glue has a second thickness less than about 10 μm.

10. The method of claim 8, further comprising dispensing a second glue between the first optical chiplet and a second laser die, wherein after the dispensing the second glue the second glue has a second thickness less than about 10 μm.

11. The method of claim 8, further comprising simultaneously bonding the first optical chiplet and the laser die to a substrate.

12. The method of claim 11, wherein the substrate is an integrated fan out substrate.

13. The method of claim 12, wherein the integrated fan out substrate comprises a local silicon interconnect.

14. The method of claim 8, further comprising using an edge coupler within the first optical chiplet as an alignment mark during the moving at least one of the first chuck and the second chuck.

15. An optical device comprising:
a first optical chiplet; and
a laser die adjacent to the first optical chiplet, wherein a first distance between the laser die and the first optical chiplet is less than about 10 μm.

16. The optical device of claim 15, further comprising a first glue extending from the first optical chiplet and the laser die.

17. The optical device of claim 15, further comprising a second optical chiplet, wherein a second distance between the first optical chiplet and the second optical chiplet is less than about 10 μm.

18. The optical device of claim 17, further comprising a second laser die, wherein a third distance between the first optical chiplet and the second laser die is less than about 10 μm.

19. The optical device of claim 15, further comprising a local silicon interconnect connecting the first optical chiplet to an electronic integrated circuit.

20. The optical device of claim 19, further comprising a metallization layer located on an opposite side of the local silicon interconnect from the first optical chiplet.
